(19) United States
(12) Patent Application Publication
(10) Pub. No.: US 2023/0368320 A1
(43) Pub. Date: Nov. 16, 2023

(54) AUTOMATED DETECTION OF EMPLOYEE CAREER PATHWAYS

(71) Applicant: BizMerlinHR Inc., Reston, VA (US)

(72) Inventors: Amrinder Arora, Centreville, VA (US); Karamveer Singh, Ludhiana (IN); Riya Singh, Ludhiana (IN)

(21) Appl. No.: 17/740,962

(22) Filed: May 10, 2022

(51) Int. Cl. G06Q 50/20

(52) U.S. Cl. CPC G06Q 50/2057

(57) ABSTRACT

An approach is disclosed for automated detection of employee career pathways extracted from historical records which includes profile transitions and a tracked history. The historical data is filtered to identify standardized pathways and individual pathways. The identified standardized pathways and individual pathways are analytically analyzed based on frequency and occurrence to generate one or more career pathways where the generated career pathways include one or more promotions and lateral moves. The generated career pathways are written to a database.

### BACKGROUND

The present invention relates to a computing environment, and more particularly to a computer program, method, and system for automatically detecting employee career pathways.

### SUMMARY

According to one embodiment of the invention, there is a method that includes a processor and a local storage device accessible by the processor for providing career path guidance. Historical data associated with one or more individuals is received where the historical data associated with the one or more individuals includes profile transitions and a tracked history; The historical data is analytically analyzed to generate career pathways where the generated career pathways include promotions and lateral moves. The generated pathways are decomposed into a plurality of career pathways.

According to one embodiment of the invention, there is provided an information handling system including at least one processor executing instructions implementing steps of the method that provides career path guidance.

According to one embodiment of the invention, there is provided a computing program product executing instructions having the steps of the method that provides career path guidance.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a flow of automated career paths processing a history file;

FIG. 2 depicts an embodiment of a history file;

FIG. 3 depicts examples of career paths;

FIG. 4 depicts a schematic flow for an embodiment of a user interface (UI) for history processing; and

FIG. 5 depicts a schematic view of a processing system wherein the methods of this invention may be implemented.

### DETAILED DESCRIPTION

Identifying, cultivating, and retaining talent in today's high employment environment are complex and challenging tasks for every manager. Skills are difficult to acquire, and many organizations invest heavily to evolve and upgrade their workforce, only to have valuable employees move on to other opportunities—elsewhere. Programs to train and continually assist employees with their career objectives are essential.

Traditionally managers have known the critical importance of employee retention and many studies have attempted to identify those elements of an employee's job satisfaction that contribute to their retention. For many years those studies were focused on the termination side of the coin and why employees tend to overcome the usual human inertia and decide to move on. Both job satisfaction and work environment have played heavily as the general categories for why employees leave. But the other side of the coin is “why do they stay?”

As employers learned to become competitive in a job market where employees have many options, they have turned increasingly toward the obvious tangible “rewards” of benefits like pay and pay raises, time off, paid training and education, retirement, etc. But astute employers have also focused on the intangibles of retention that are much more difficult to determine and manage—like career progression.

In addition to the obvious list of benefits they provide, employers are now looking at other critical elements of retention—like career progression. Today's employees are smart enough to know that happiness today doesn't necessarily mean happiness tomorrow. They want to be able to visualize their future. Abraham Maslow (Maslow (1943) Psychological Review 50, pp. 370-396, A Theory of Human Motivation) defined a hierarchy of human needs that ultimately ends with what he called “self-actualization”—the process of “realizing personal potential, self-fulfillment, seeking personal growth and peak experiences. A desire to become everything one is capable of becoming.” According to Maslow and other Humanists, growth needs do not stem from the lack of something, but rather from a desire to grow as a person. Once the lower-level growth needs have been reasonably satisfied (e.g., psychological, safety, love, esteem), one may be able to reach the highest level of self-actualization.

Organizations are discovering that promoting from within is a double benefit. By encouraging and guiding employees to grow within the organization's structure, a large part of the retention problem is solved. At the same time, by creating a culture of progress and advancement, employees are continually aware of their opportunities to define and strive for their own self-fulfillment. But, as organization's grow, defining a large range of potential career paths becomes increasingly complex and prohibitive. What are the proper metrics that can not only define where an employee resides inside of the organization's hierarchy, but what are the available opportunities that are available to him? What are the steps and how are they defined? What are the hierarchies of skills within a particular specialty and how do they relate to the structure of the organization? Does career planning also include the possibility of lateral as well as vertical progression? Are individual resumes for experience and education outside of the organization relevant, or should only performance within the organization be considered? These and many other challenges exist for any organization that wants to capture the obvious benefits of an internal career path program for its employees.

As Human Resources Information Management systems have evolved there are many functions and processes that have greatly benefited by automation. The most successful have been the functions that deal with easily identified data. Payroll, time off, training and even new personnel hiring are rich with data that can be directly incorporated into accurate and repeatable automated processes. As artificial intelligence like machine learning is introduced into HR support, data like that produced by such functions as performance measurement, can be applied to advanced inference methods. But the means to scan the skills, positions, hierarchy, responsibilities, and qualifications that prescribe the potentials for career progression have remained beyond reach.

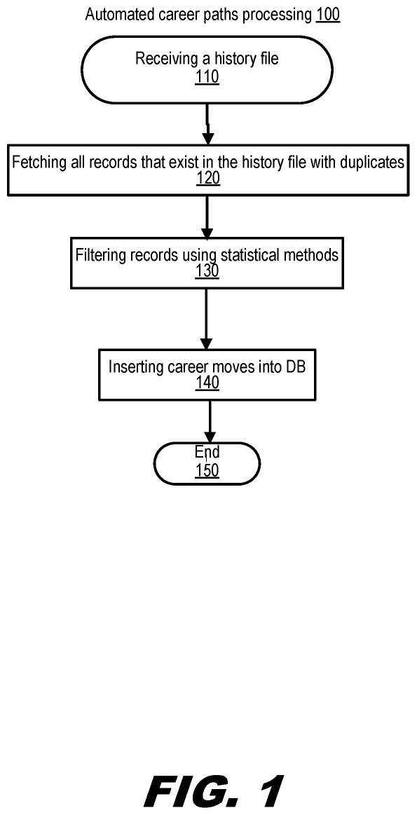

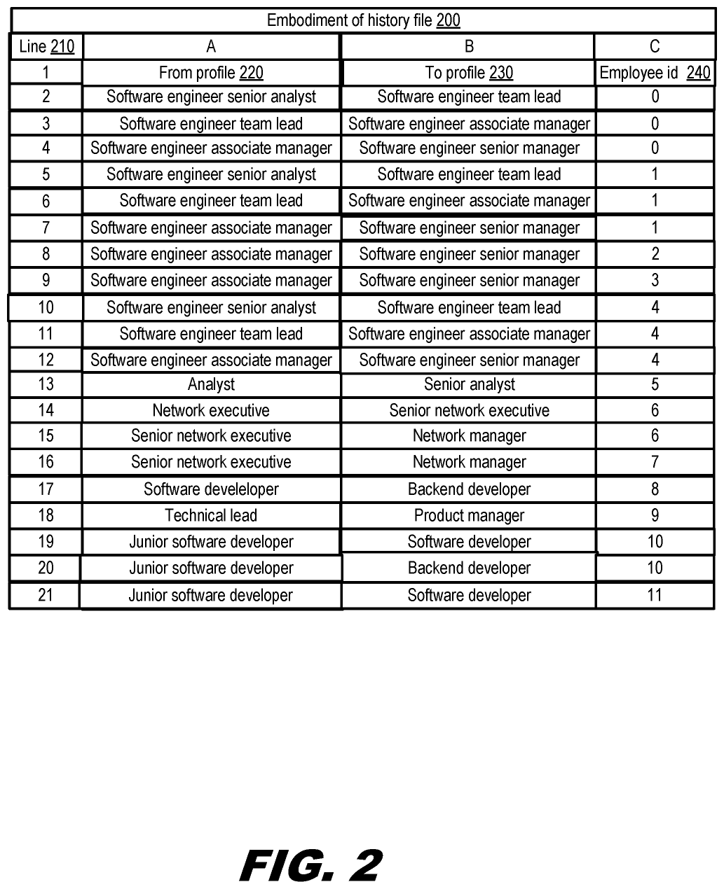

FIG. 1 shows the steps taken by a process that automates career path processing 100. At step 110, the process receives a history file. The history file may include, for example, but not limited to employment records at a current company, an imported resume, application data, such as, project assignments and quality assessment, and the like. In an embodiment, the history file itself may be a structured format, such as, a list or spreadsheet like that depicted in FIG. 2. In another embodiment, the history file may have an unstructured format requiring natural language processing to identify important information and extract the information needed for processing. An artificial intelligence model may be trained on various input file formats to convert the information into a structured format such as that depicted in FIG. 2. At step 120, the process fetches all records that exist in the history file with duplicates. The records may include data, such as, timestamps, unique employee identifications, and profile transitions between positions. The records may be sorted, for example, but not limited to, by timelines based on time stamps and separated by assignments, job titles, projects, and the like. The records may be separated into verified or tracked history with assignments, such as, positions. The tracked history may be, for example, an assignment as a programmer, a lateral move into quality assurance, or a promotion from an entry level programmer to an experienced programmer, a senior programmer, or a team lead. At step 130, the process filters records using statistical methods. In an embodiment, employee records depicting job positions of all or most of the employees may be submitted in a history file over an extended period of time supporting analytic analysis. The analytic analysis of the filtered records may include calculating frequency and occurrence percentage applied to one or more career pathways and the tracked positions. With a statistically significant number of employees following common career pathways, the identified common career pathways may be identified as standardized pathways. Alternatively, an employee that takes uncommon roles or positions, the career paths of the employee may be identified as an individual career pathway. At step 140, the process inserts career moves into a database (DB). At step 150, the process ends.

FIG. 2 depicts an embodiment of processing of the history file 200. The history file processing is depicted in a spread sheet where the line 210 is a header of line numbers in the spread sheet. The from profile 220 is a header of column A of the spread sheet representing input data from the received history file. In an embodiment, the to profile 230 is a header of column B of the history input spread sheet representing a career position of an employee changing position from the from profile 220 position to the to profile 230 position. In an embodiment, the to profile 230 position may be in an output of a processed history file, representing potential career upward movement. The employee id 240 is a unique identification for each employee where different entries for the same employee represent actual career paths, possible career paths, or lateral moves for the same employee.

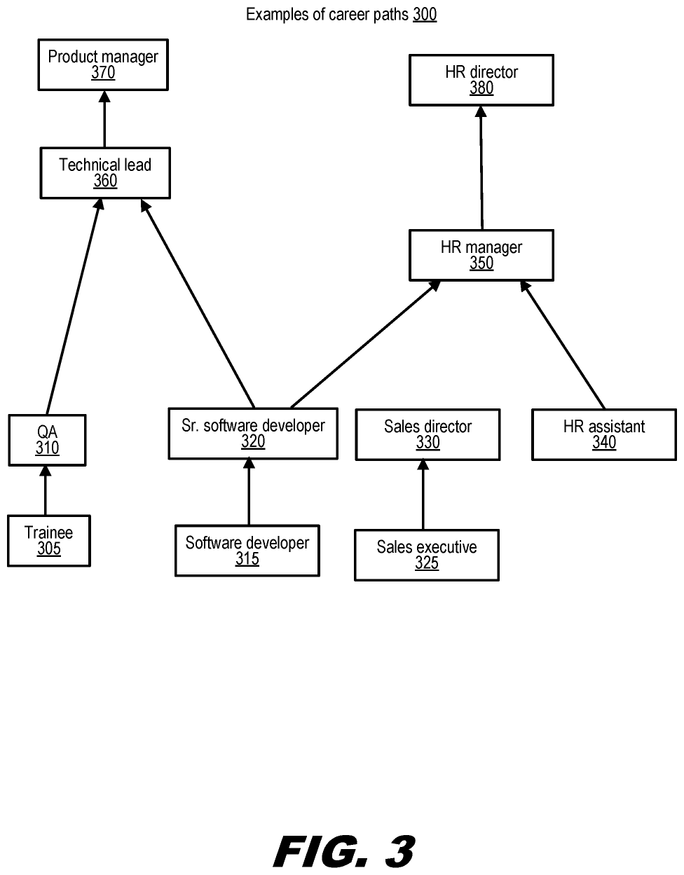

FIG. 3 depicts examples of possible career paths 300. A Trainee 305 may become a quality assurance (QA) 310 and proceed to become a technical lead 360. The technical lead 360 may become a product manger 370. Similarly, a software developer 315 may advance to become a senior (Sr.) software developer 320 who also may become the technical lead 360 or proceed to become a human resource (HR) manager 350. An HR assistant 340 may also become the HR manager 360 who may become an HR director 360. A sales executive 325 may become a sales director 330.

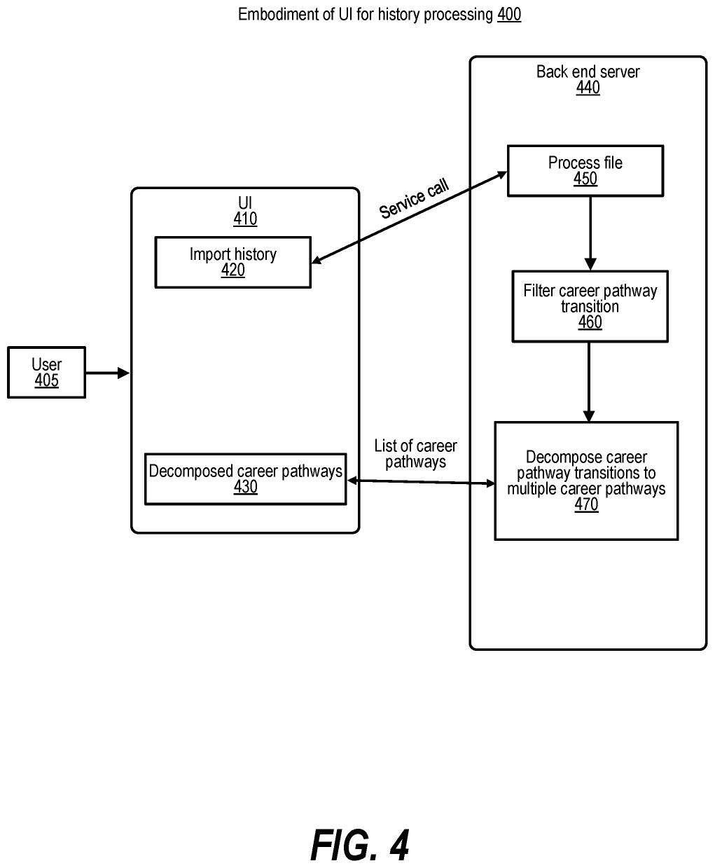

FIG. 4 depicts an embodiment of a user interface (UI) for history file processing 400. The user 405 utilizes the UI 410. The UI may be for example, but not limited to, a graphical user interface (GUI), a command line interface (CLI), a web browser, an instant messaging application, and the like. The information may be displayed with emphasis separating common career pathways from individual or unusual career pathways. In an example embodiment, green may be used to indicate common career pathways and purple may be used to indicate unusual career pathways.

In an embodiment, the UI 410 imports a history file 420 by making a service call through a back-end server 440 which processes the file 450. In an example embodiment, the input file may be a structured file with headers, such as, but not limited to, a list, a spread sheet, like an .xlsx, a .csv file, and the like, such as that depicted in FIG. 2. In some embodiments, fields may be required, such as a from position and a to position, with the same value in both columns identifying no transition. In other embodiments, more general support may be allowed utilizing natural language processing and artificial intelligence to identify people, positions, and career pathways. In an embodiment, the artificial intelligence model may be trained to work on data from a specific company utilizing supervised feedback. The processing proceeds to step 460 which filters career pathway transitions. In an embodiment, The process proceeds to step 470 by decomposing career pathway transitions to multiple career pathways. In an embodiment, filtering and decomposition of Career Pathways may be based on source nodes, where a source node is the from profile 220 instance that is not present in any of the to profile 230 instances. The list of career pathways may be stored in a data store, such as, a database supporting queries or put in a spread sheet such as depicted in FIG. 2 and is represented as decomposed career pathways 430. In an embodiment, the career pathway transitions are based on statistical analysis, such as, being derived from a frequency of occurrence of combinations of career pathway transition entities with input from a specific company that exceed predefined threshold values. In an embodiment, data may be combined from multiple companies and weighted toward statistics derived from a specific company.

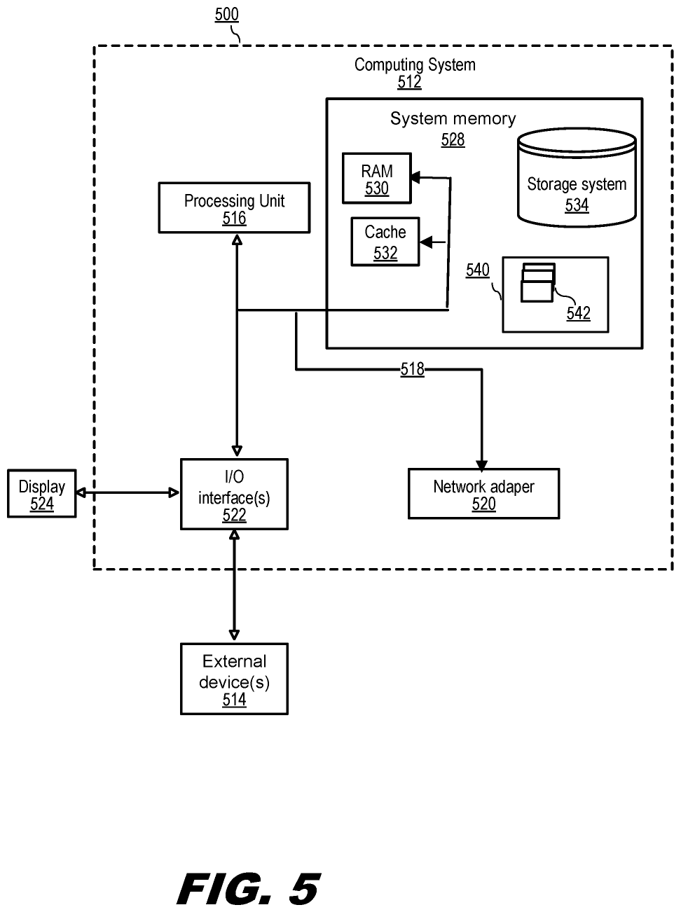

Referring to FIG. 5, a schematic view of a processing system 500 is shown wherein the methods of this invention may be implemented. The processing system 500 is only one example of a suitable system and is not intended to suggest any limitation as to the scope of use or functionality of embodiments of the invention described herein. Regardless, the system 500 can implement and/or performing any of the functionality set forth herein. In the system 500 there is a computer system 512, which is operational with numerous other general purpose or special purpose computing system environments or configurations. Examples of well-known computing systems, environments, and/or configurations that may be suitable for use with the computer system 512 include, but are not limited to, personal computer systems, server computer systems, thin clients, thick clients, handheld or laptop devices, multiprocessor systems, microprocessor-based systems, set top boxes, programmable operator electronics, network PCs, minicomputer systems, mainframe computer systems, and distributed cloud computing environments that include any of the above systems or devices, and the like.

The computer system 512 may be described in the general context of computer system-executable instructions, such as program modules, being executed by a computer system. Generally, program modules may include routines, programs, objects, components, logic, data structures, and so on that perform tasks or implement abstract data types. The computer system 512 may be practiced in distributed cloud computing environments where tasks are performed by remote processing devices that are linked through a communications network. In a distributed cloud computing environment, program modules may be in both local and remote computer system storage media including memory storage devices.

As shown in FIG. 5, the computer system 512 in the system environment 500 is shown in the form of a general-purpose computing device. The components of the computer system 512 may include, but are not limited to, a set of one or more processors or processing units 516, a system memory 528, and a bus 55 that couples various system components including the system memory 528 to the processor 516.

The bus 55 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA) bus, the Micro Channel Architecture (MCA) bus, the Enhanced ISA (EISA) bus, the Video Electronics Standards Association (VESA) local bus, and the Peripheral Component Interconnects (PCI) bus.

The computer system 512 typically includes a variety of computer system readable media. Such media may be any available media that is accessible by the computer system 512, and it includes both volatile and non-volatile media, removable and non-removable media.

The system memory 528 can include computer system readable media in the form of volatile memory, such as random-access memory (RAM) 530 and/or a cache memory 532. The computer system 512 may further include other removable/non-removable, volatile/non-volatile computer system storage media. By way of example only, a storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 55 by one or more data media interfaces. As will be further depicted and described below, the system memory 528 may include at least one program product having a set (e.g., at least one) of program modules 542 that are configured to carry out the functions of embodiments of the invention.

A program/utility 540, having the set (at least one) of program modules 542, may be stored in the system memory 528 by way of example, and not limitation, as well as an operating system, one or more application programs, other program modules, and program data. Each of the operating systems may have one or more application programs, other program modules, and program data or some combination thereof, and may include an implementation of a networking environment. The program modules 542 generally carry out the functions and/or methodologies of embodiments of the invention as described herein.

The computer system 512 may also communicate with a set of one or more external devices 514 such as a keyboard, a pointing device, a display 524, a tablet, a digital pen, etc. wherein these one or more devices enable a user to interact with the computer system 512; and/or any devices (e.g., network card, modem, etc.) that enable the computer system 512 to communicate with one or more other computing devices. Such communication can occur via Input/Output (I/O) interfaces 522. These include wireless devices and other devices that may be connected to the computer system 512, such as, a USB port, which may be used by a tablet device (not shown). Still yet, the computer system 512 can communicate with one or more networks such as a local area network (LAN), a general wide area network (WAN), and/or a public network (e.g., the Internet) via a network adapter 520. As depicted, a network adapter 520 communicates with the other components of the computer system 512 via the bus 55. Although not shown, other hardware and/or software components could be used in conjunction with the computer system 512. Examples include, but are not limited to microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method that includes a processor and a local storage device accessible by the processor for providing career path guidance, comprising:
receiving historical data associated with a plurality of individuals, wherein the historical data associated with the plurality of individuals includes profile transitions and a tracked history;
analytically analyzing the historical data to generate career pathways wherein the generated career pathways include promotions and lateral moves; and
decomposing the generated pathway into a plurality of career pathways.

2. The method of claim 1, wherein the tracked history is extracted from the historical data.

3. The method of claim 1, wherein the historical data includes timestamps, unique employee identifications, and profile transitions.

4. The method of claim 3, wherein the analytically analyzing comprises statistical analysis.

5. The method of claim 4, wherein the statistical analysis includes calculating frequency and occurrence percentage applied to the plurality of career pathways and the profile transitions.

6. The method of claim 5, further comprising:
recording the profile transitions into a database.

7. The method of claim 1, wherein the plurality of career pathways includes a standardize pathway and an individual career pathway.

8. The method of claim 1, wherein the historical data includes job role transitions, unique employee identifications, time stamp of the job role transitions, and pay scales.

9. The method of claim 8, further comprising:
presenting a visual representation of career pathways.

10. An information handling system comprising:
one or more processors;
a memory coupled to at least one of the processors;
a network interface that connects the local node to one or more remote nodes; and
a set of computer program instructions stored in the memory and executed by at least one of the processors in order to perform actions comprising:
receiving historical data associated with a plurality of individuals, wherein the historical data associated with the plurality of individuals includes profile transitions and a tracked history;
analytically analyzing the historical data to generate career pathways wherein the generated career pathways include promotions and lateral moves; and
decomposing the generated pathway into a plurality of career pathways.

11. The information handling system of claim 10, wherein the tracked history is extracted from the historical data.

12. The information handling system of claim 10, wherein the historical data includes timestamps, unique employee identifications, and profile transitions.

13. The information handling system of claim 12, wherein the analytically analyzing comprises statistical analysis.

14. The information handling system of claim 13, wherein the statistical analysis includes calculating frequency and occurrence percentage applied to the plurality of career pathways and the profile transitions.

15. A computer program product stored in a computer readable storage medium, comprising computer program code that, when executed by an information handling system (a local node), performs actions comprising:
receiving historical data associated with a plurality of individuals, wherein the historical data associated with the plurality of individuals includes profile transitions and a tracked history;
analytically analyzing the historical data to generate career pathways wherein the generated career pathways include promotions and lateral moves; and
decomposing the generated pathway into a plurality of career pathways.

16. The computer program product of claim 15, wherein the tracked history is extracted from the historical data.

17. The computer program product of claim 15, wherein the historical data includes timestamps, unique employee identifications, and profile transitions.

18. The computer program product of claim 17, wherein the analytically analyzing comprises statistical analysis.

19. The computer program product of claim 18, wherein the statistical analysis includes calculating frequency and occurrence percentage applied to the plurality of career pathways and the profile transitions.

20. The computer program product of claim 19, further comprising:
recording the profile transitions into a database.
